(19) United States
(12) Patent Application Publication
(10) Pub. No.: US 2015/0181672 A1
(43) Pub. Date: Jun. 25, 2015

(54) METHOD OF DRIVING A LIGHT SOURCE, LIGHT SOURCE DRIVING APPARATUS FOR PERFORMING THE METHOD AND DISPLAY APPARATUS HAVING THE LIGHT SOURCE DRIVING APPARATUS

(71) Applicant: SAMSUNG DISPLAY CO., LTD., Yongin-City (KR)

(72) Inventors: Min-Soo CHOI, Asan-si (KR); Young-Sup KWON, Gwangmyeong-si (KR); Myoung-Soo KIM, Asan-si (KR)

(21) Appl. No.: 14/453,998

(22) Filed: Aug. 7, 2014

(30) Foreign Application Priority Data
Dec. 19, 2013 (KR) 10-2013-0159706

(51) Int. Cl. H05B 33/08; G09G 3/36

(52) U.S. Cl. CPC H05B 33/0845; H05B 33/0815; G09G 3/3648; H05B 33/083; G09G 2320/064; G09G 2300/08

(57) ABSTRACT

A method of driving light source includes detecting a frequency of a dimming signal, which controls a luminance of a light source, to output a frequency detection signal, and outputting a current control signal, which controls a current flow in the light source, based on the frequency detection signal, where the current control signal has a frequency substantially the same as the frequency of the dimming signal.

This application claims priority to Korean Patent Application No. 10-2013-0159706, filed on Dec. 19, 2013, and all the benefits accruing therefrom under 35 U.S.C. §119, the content of which in its entirety is herein incorporated by reference.

### BACKGROUND

1. Field

Exemplary embodiments of the invention relate to a method of driving a light source, a light source driving apparatus for performing the method, and a display apparatus having the light source driving apparatus. More particularly, exemplary embodiments of the invention relate to a method of driving a light source providing light to a display panel, a light source driving apparatus for performing the method, and a display apparatus having the light source driving apparatus.

2. Description of the Related Art

A liquid crystal display apparatus is a non-emitting display apparatus, and a light source for providing light to a display panel of the liquid crystal display apparatus is typically included in the liquid crystal display apparatus.

A luminance of the light source may be controlled in a dimming method. In the dimming method, the luminance of the light source may be controlled by a dimming signal, and the dimming signal may be a pulse width modulation (“PWM”) signal. Thus, the luminance of the light source may be controlled based on a pulse width of the dimming signal.

A current flow in a light source of the light source part may be controlled by turning on and off of a switching element. Thus, the switching element includes a control terminal that receives a current control signal for controlling the current flow in the light source.

However, a frequency of the current control signal is typically greater than a frequency of the dimming signal. Therefore, the number of turning on and off of the switching element increases, and thus heat of the switching element and switching loss of the switching element may increase.

### SUMMARY

Exemplary embodiments of the invention provide a method of driving a light source with decreased heat of a switching element and switching loss of the switching element.

Exemplary embodiments of the invention also provide a light source driving apparatus for performing the above-mentioned method.

Exemplary embodiments of the invention also provide a display apparatus including the above-mentioned light source driving apparatus.

According to an exemplary embodiment of the invention, a method of driving a light source includes detecting a frequency of a dimming signal, which controls a luminance of the light source, to output a frequency detection signal, and outputting a current control signal, which controls a current flow in the light source, based on the frequency detection signal, where the current control signal has a frequency substantially the same as the frequency of the dimming signal.

In one embodiment, the method may further include detecting a duty ratio of the dimming signal to output a duty ratio detection signal.

In one embodiment, the method may further include outputting a synchronization signal, which is synchronized with the dimming signal, based on the frequency detection signal.

In one embodiment, the synchronization signal may have a triangular waveform.

In one embodiment, the method may further include multiplying the synchronization signal by the duty ratio detection signal to output a reference signal.

In one embodiment, the reference signal may have a triangular waveform.

In one embodiment, the method may further include detecting the current flow in the light source to output a current detection signal.

In one embodiment, outputting the current control signal may include comparing the reference signal with the current detection signal.

In one embodiment, the method may further include comparing a current detection signal with a first reference voltage to output a comparison signal, where the current detection signal is generated based on the current flow in the light source, and the first reference voltage is substantially same as a reference voltage, controlling a step of an up-down counter based on the comparison signal to output an up-down counter signal, controlling a duty ratio of a reference signal based on the up-down counter signal, controlling a dimming step of a digital-analog converting part based on the up-down counter signal to output an analog signal, and adding the reference voltage to the analog signal to output a second reference voltage.

According to an exemplary embodiment of the invention, a light source driving apparatus includes a frequency detecting part configured to detect a frequency of a dimming signal, which controls a luminance of a light source, to output a frequency detection signal and a current control signal outputting part configured to output a current control signal, which controls a current flow in the light source, based on the frequency detection signal, wherein the current control signal has a frequency substantially the same as the frequency of the dimming signal.

In one embodiment, the light source driving apparatus may further include a duty ratio detecting part configured to detect a duty ratio of the dimming signal to output a duty ratio detection signal.

In one embodiment, the light source driving apparatus may further include a synchronization signal generating part configured to receive the frequency detection signal to output a synchronization signal, which is synchronized with the dimming signal, based on the frequency detection signal.

In one embodiment, the light source driving apparatus may further include a multiplying part configured to multiply the synchronization signal by the duty ratio detection signal to output a reference signal.

In one embodiment, the light source driving apparatus may further include a current detecting part configured to detect the current flow in the light source to output a current detection signal.

In one embodiment, the light source driving apparatus may further include a comparing part configured to compare a current detection signal with a first reference voltage to output a comparison signal, an up-down counter part configured to control a step of an up-down counter based on the comparison signal to output an up-down counter signal, a reference signal generating part configured to control a duty ratio of a reference signal based on the up-down counter signal and configured to output the reference signal synchronized with the dimming signal, a digital-analog converting part configured to control a dimming step of the digital-analog converting part based on the up-down counter signal to output an analog signal, and an adding part configured to add the reference voltage to the analog signal to output a second reference voltage. In such an embodiment, the current detection signal is generated based on the current flow in the light source, and the first reference voltage is substantially the same as a reference voltage.

According to an exemplary embodiment of the invention, a display apparatus includes a display panel configured to display an image, a light source part configured to provide light to the display panel, and a light source driving apparatus including a frequency detecting part configured to detect a frequency of a dimming signal, which controls a luminance of a light source in the light source part, to output a frequency detection signal, and a current control signal outputting part configured to output a current control signal, which controls a current flow in the light source, based on the frequency detection signal, where the current control signal has a frequency substantially the same as the frequency of the dimming signal.

In one embodiment, the light source part may include a plurality of light source strings connected to each other in parallel.

In one embodiment, each of the light source strings may include a plurality of light sources.

In one embodiment, the current flows in the light source strings may have frequencies substantially same as the frequency of the dimming signal.

In one embodiment, the current flows in the light source strings may have pulse widths different from each other.

According to exemplary embodiments of the invention, a frequency of a current control signal for controlling a current flow in a light source is substantially the same as a frequency of a dimming signal, such that a number of turning on and off of a switching element that receives the current control signal may be decreased, and thus heating of the switching element and switching loss of the switching element may be decreased.

### BRIEF DESCRIPTION OF THE DRAWINGS

The above and other features of the invention will become more apparent by describing in detailed example embodiments thereof with reference to the accompanying drawings, in which:

FIG. 1 is a block diagram illustrating an exemplary embodiment of a light source apparatus according to the invention;

FIG. 2 is timing diagrams illustrating an exemplary embodiment of a dimming signal, a first current, a second current and an n-th current of FIG. 1;

FIG. 3 is a flow chart illustrating an exemplary embodiment of a method of driving a light source performed by the light source driving apparatus of FIG. 1;

FIG. 4 is a block diagram illustrating an exemplary embodiment of a display apparatus including the light source apparatus of FIG. 1;

FIG. 5 is a block diagram illustrating an alternative exemplary embodiment of a light source apparatus according to the invention;

FIG. 6 is a flow chart illustrating an exemplary embodiment of a method of driving a light source performed by the light source driving apparatus of FIG. 5; and

FIG. 7 is a block diagram illustrating an exemplary embodiment of a display apparatus including the light source apparatus of FIG. 5.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, exemplary embodiments of the invention will be described in detail with reference to the accompanying drawings.

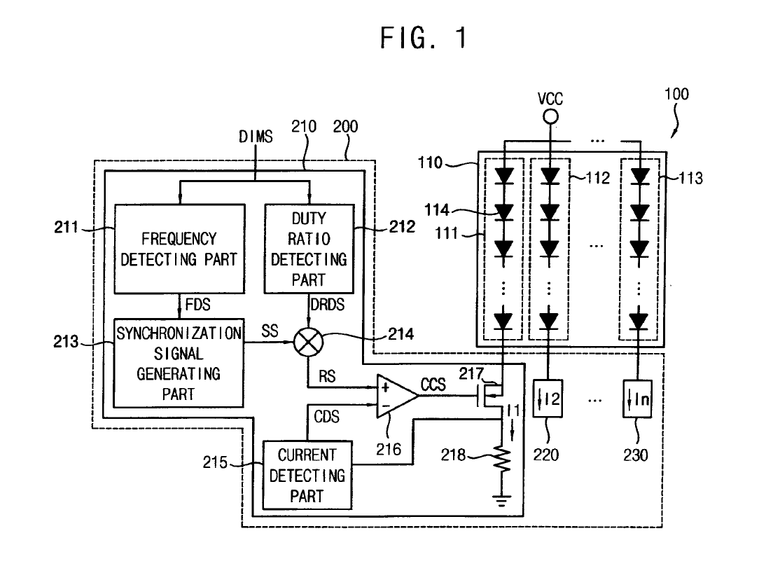

FIG. 1 is a block diagram illustrating an exemplary embodiment of a light source apparatus according to the invention.

Referring to FIG. 1, an exemplary embodiment of the light source apparatus 100 includes a light source part 110 and a light source driving apparatus 200.

The light source part 110 generates light, and a luminance of the light source part 110 may be controlled by a pulse width of a dimming signal DIMS. The light source part 110 may include first to n-th light source strings, e.g., a first light source string 111, a second light source string 112 and an n-th light source string 113. In an exemplary embodiment, the light source strings 111, 112 and 113 are connected to each other in parallel, and receive a power voltage VCC. In such an embodiment, each of the light source strings 111, 112 and 113 may include a plurality of light sources 114. In one exemplary embodiment, for example, the light source 114 may be a light emitting diode (“LED”).

A first current I1 flows in the first light source string 111 of the light source strings 111, 112 and 113. A second current I2 flows in the second light source string 112 of the light source strings 111, 112 and 113. An n-th current In flows in the n-th light source string 113 of the light source strings 111, 112 and 113.

The light source driving apparatus 200 includes first to n-th light source driving apparatuses 210, 220 and 230. The first to n-th light source driving apparatuses 210, 220 and 230 drive the first to n-th light source strings 111, 112 and 113, respectively.

The first light source driving apparatus 210 includes a frequency detecting part 211, a duty ratio detecting part 212, a synchronization signal generating part 213, a multiplying part 214, a current detecting part 215, a current control signal outputting part 216 and a current controlling part 217.

The frequency detecting part 211 receives the dimming signal DIMS, and detects a frequency of the dimming signal DIMS to output a frequency detection signal FDS including information on the frequency of the dimming signal DIMS.

The duty ratio detecting part 212 receives the dimming signal DIMS, and detects a duty ratio of the dimming signal DIMS to output a duty ratio detection signal DRDS including information on the duty ratio of the dimming signal DIMS.

The synchronization signal generating part 213 receives the frequency detection signal FDS from the frequency detecting part 211, and outputs a synchronization signal SS, which is synchronized with the dimming signal DIMS, from the frequency detection signal FDS. In an exemplary embodiment, the synchronization signal SS may have a triangular waveform.

The multiplying part 214 receives the duty ratio detection signal DRDS from the duty ratio detecting part 212 and the synchronization signal SS from the synchronization signal generating part 213, and performs a multiplication operation on the synchronization signal SS and the duty ratio detection signal DRDS to output a reference signal RS. In an exemplary embodiment, the reference signal RS may have a triangular waveform. In such an embodiment, a frequency of the reference signal RS may be substantially the same as the frequency of the dimming signal DIMS.

The current detecting part 215 detects a current flow in the light source 114 to output a current detection signal CDS. In an exemplary embodiment, the current detecting part 215 of the first light source driving apparatus 210 detects the first current I1 flowing in the first light source string 111 to output the current detection signal CDS. The current detecting part 215 may detect a peak value of the first current I1 flowing in the first light source string 111.

The current control signal outputting part 216 compares the reference signal RS with the current detection signal CDS to output a current control signal CCS which controls the current flow in the light source 114. In an exemplary embodiment, the current control signal outputting part 216 receives the reference signal RS from the multiplying part 214 and the current detection signal CDS from the current detecting part 215, and compares the reference signal RS with the current detection signal CDS to output the current control signal CCS for controlling the first current I1 flowing in the first light source string 111. In an exemplary embodiment, the current control signal outputting part 216 may include an operational amplifier having a non-inverting input terminal for receiving the reference signal RS, an inverting terminal for receiving the current detection signal CDS, and an output terminal for outputting the current control signal CCS. In such an embodiment, the current control signal outputting part 216 may be a comparator comparing the reference signal RS with the current detection signal CDS. The current control signal CCS may have a square waveform.

The current controlling part 217 controls the current flow in the light source 114 based on the current control signal CCS. In an exemplary embodiment, the current controlling part 217 receives the current control signal CCS from the current control signal outputting part 216, and controls the first current I1 flowing in the first light source string 111 based on the current control signal CCS. The current controlling part 217 may control a pulse width of the first current I1. The current controlling part 217 may include a switching element having a source terminal connected to the first light source string 111, a gate terminal for receiving the current control signal CCS, and a drain terminal in which the first current I1 flows. In one exemplary embodiment, for example, the switching element may be a field effect transistor (“FET”).

The first light source driving apparatus 210 may further include a root mean square (“RMS”) value detecting part 218 connected between the current controlling part 217 and a ground terminal. The RMS value detecting part 218 detects an RMS value of the current flow in the light source 114. In an exemplary embodiment, the RMS value detecting part 218 detects an RMS value of the first current I1 flowing in the first light source string 111. The RMS value detecting part 218 may include a resistor having a first terminal connected to the current controlling part 217 and a second terminal connected to the ground terminal.

The second light source driving apparatus 220 is connected to the second light source string 112, and controls the second current I2 flowing in the second light source string 112. The second light source driving apparatus 220 is substantially the same as the first light source driving apparatus 210 except that the second light source driving apparatus 220 is connected to the second light source string 112 and controls the second current I2.

The n-th light source driving apparatus 230 is connected to the n-th light source string 113, and controls the n-th current In flowing in the n-th light source string 113. The n-th light source driving apparatus 230 is substantially the same as the first light source driving apparatus 230 except that the n-th light source driving apparatus 230 is connected to the n-th light source string 113 and controls the n-th current In.

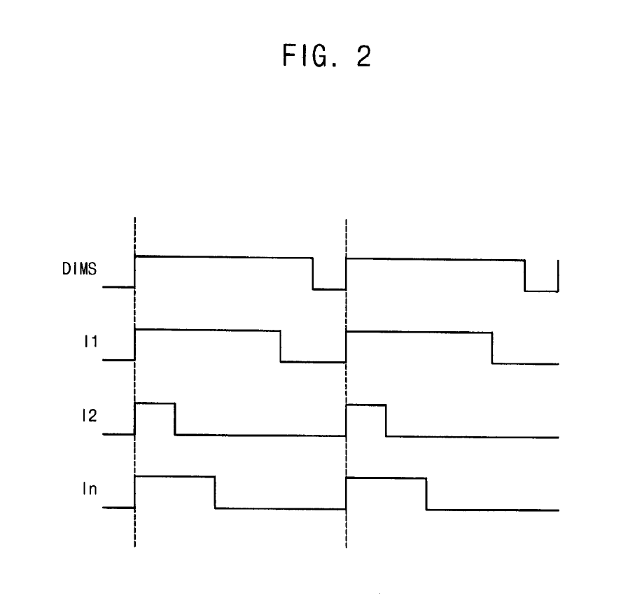

FIG. 2 is timing diagrams illustrating an exemplary embodiment of the dimming signal DIMS, the first current I1, the second current I2 and the n-th current In of FIG. 1.

Referring to FIGS. 1 and 2, each of a frequency of the first current I1, a frequency of the second current I2 and a frequency of the n-th current In is substantially the same as the frequency of the dimming signal DIMS. However, a pulse width of the first current I1, a pulse width of the second current I2 and a pulse width of the n-th current In may be different from each other.

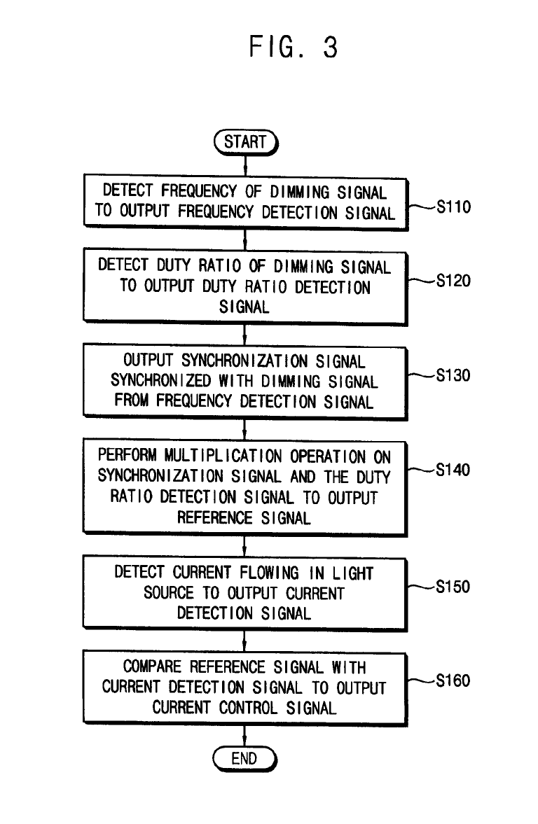

FIG. 3 is a flow chart illustrating an exemplary embodiment of a method of driving a light source performed by the light source driving apparatus of FIG. 1.

Referring to FIGS. 1 to 3, the frequency of the dimming signal DIMS is detected and the frequency detection signal FS is outputted (S110). In an exemplary embodiment, the frequency detecting part 211 receives the dimming signal DIMS, and detects the frequency of the dimming signal DIMS to output the frequency detection signal FDS.

The duty ratio of the dimming signal DIMS is detected, and the duty ratio detection signal DRDS is thereby outputted (S120). In an exemplary embodiment, the duty ratio detecting part 212 receives the dimming signal DIMS, and detects the duty ratio of the dimming signal DIMS to output the duty ratio detection signal DRDS.

The synchronization signal SS synchronized with the dimming signal DIMS is outputted from the frequency detection signal FDS (S130). In an exemplary embodiment, the synchronization signal generating part 213 receives the frequency detection signal FDS from the frequency detecting part 211, and outputs the synchronization signal SS synchronized with the dimming signal DIMS from the frequency detection signal FDS. The synchronization signal SS may have the triangular waveform.

The multiplication operation on the synchronization signal SS and the duty ratio detection signal DRDS is performed and the reference signal RS is outputted (S140). In an exemplary embodiment, multiplying part 214 receives the duty ratio detection signal DRDS from the duty ratio detecting part 212 and the synchronization signal SS from the synchronization signal generating part 213, and performs a multiplication operation on the synchronization signal SS and the duty ratio detection signal DRDS to output the reference signal RS. In such an embodiment, the frequency of the reference signal RS may be substantially the same as the frequency of the dimming signal DIMS.

The current flow in the light source 114 is detected, and the current detection signal CDS is thereby outputted (S150). In an exemplary embodiment, the current detecting part 215 detects the first current I1 flowing in the first light source string 111 to output the current detection signal CDS. The current detecting part 215 may detect the peak value of the first current I1 flowing in the first light source string 111.

The reference signal RS and the current detection signal CDS are compared to output the current control signal CCS (S160). In an exemplary embodiment, the current control signal outputting part 216 compares the reference signal RS with the current detection signal CDS to output the current control signal CCS for controlling the current flow in the light source 114. The current control signal outputting part 216 receives the reference signal RS from the multiplying part 214 and the current detection signal CDS from the current detecting part 215, and compares the reference signal RS with the current detection signal CDS to output the current control signal CCS controlling the first current I1 flowing in the first light source string 111. The current control signal CCS may have the square waveform.

The method of driving a light source may further include controlling the current flow in the light source based on the current control signal CCS. In an exemplary embodiment, the current controlling part 217 receives the current control signal CCS from the current control signal outputting part 216, and controls the first current I1 flowing in the first light source string 111 based on the current control signal CCS.

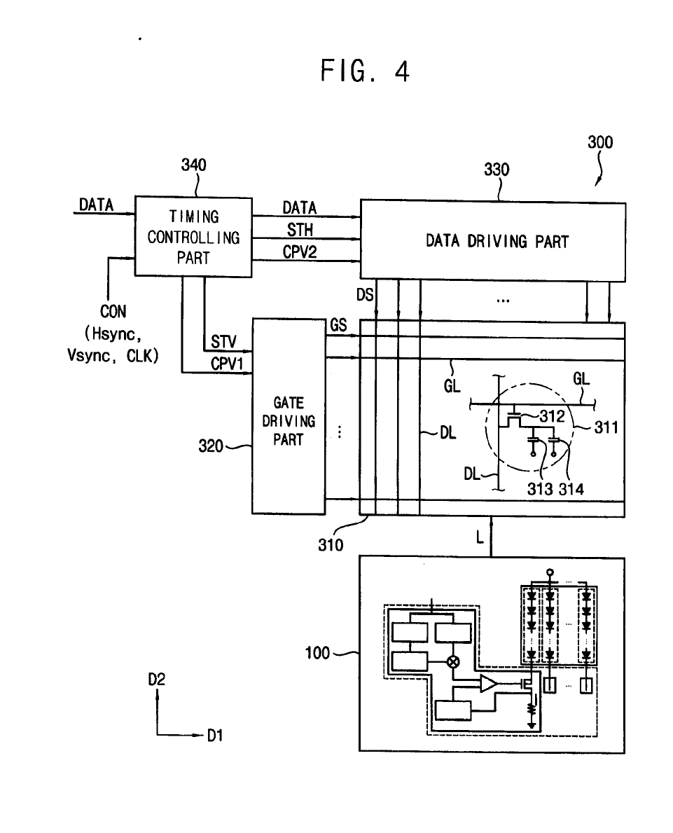

FIG. 4 is a block diagram illustrating an exemplary embodiment of a display apparatus including the light source apparatus 100 of FIG. 1.

Referring to FIGS. 1 and 4, an exemplary embodiment of the display apparatus 300 includes a display panel 310, a gate driving part 320, a data driving part 330, a timing controlling part 340 and the light source apparatus 100.

The display penal 310 receives a data signal DS based on an image data DATA provided from an outside to display an image. In one exemplary embodiment, for example, the image data DATA may be two-dimensional image data. Alternatively, the image data DATA may include a left-eye image data and a right-eye image data for displaying a three-dimensional stereoscopic image.

The display panel 310 includes gate lines GL, data lines DL and a plurality of unit pixels 311. The gate line GL extends substantially in a first direction D1, and the data line DL extends substantially in a second direction D2 perpendicular to the first direction D1. The first direction D1 may be parallel to a long side of the display panel 310, and the second direction D2 may be parallel to a short side of the display panel 310. Each of the unit pixels 311 includes a thin film transistor 312 electrically connected to a corresponding gate line of the gate lines GL and a corresponding data line of the data lines DL, a liquid crystal capacitor 313 and a storage capacitor 314 connected to the thin film transistor 311. In one exemplary embodiment, for example, the display panel 310 may be a liquid crystal display panel.

The gate driving part 320 generates a gate signal GS in response to a gate start signal STV and a gate clock signal CPV1 provided from the timing controlling part 340, and outputs the gate signal GS to the gate lines GL.

The data driving part 330 outputs the data signal DS based on the image data DATA to the data lines DL in response to a data start signal STH and a data clock signal CPV2 provided from the timing controlling part 340.

The timing controlling part 340 receives the image data DATA and a control signal CON from an outside. The control signal CON may include a horizontal synchronous signal Hsync, a vertical synchronous signal Vsync and a clock signal CLK. The timing controlling part 340 generates the data start signal STH using the horizontal synchronous signal Hsync and outputs the data start signal STH to the data driving part 330. The timing controlling part 340 generates the gate start signal STV using the vertical synchronous signal Vsync and outputs the gate start signal STV to the gate driving part 320. The timing controlling part 340 generates the gate clock signal CPV1 and the data clock signal CPV2 using the clock signal CLK, outputs the gate clock signal CPV1 to the gate driving part 320, and outputs the data clock signal CPV2 to the data driving part 330.

The light source apparatus 100 provides light to the display panel 310. The light source apparatus includes the light source part 110 and the light source driving apparatus 200.

The light source part 110 generates the light L, and the light source driving apparatus 200 drives the light source part 110.

The light source apparatus 100 of FIG. 4 is substantially the same as the light source apparatus 100 of FIG. 1, and any repetitive detailed description thereof will be omitted.

According to an exemplary embodiment, as described above, the frequency of the current control signal CCS for controlling the current flow in the light source 114 is substantially the same as the frequency of the dimming signal DIMS, such that the number of the turning on and off of the switching element that receives the current control signal CCS may be decreased, and heating of the switching element and switching loss of the switching element may be thereby decreased.

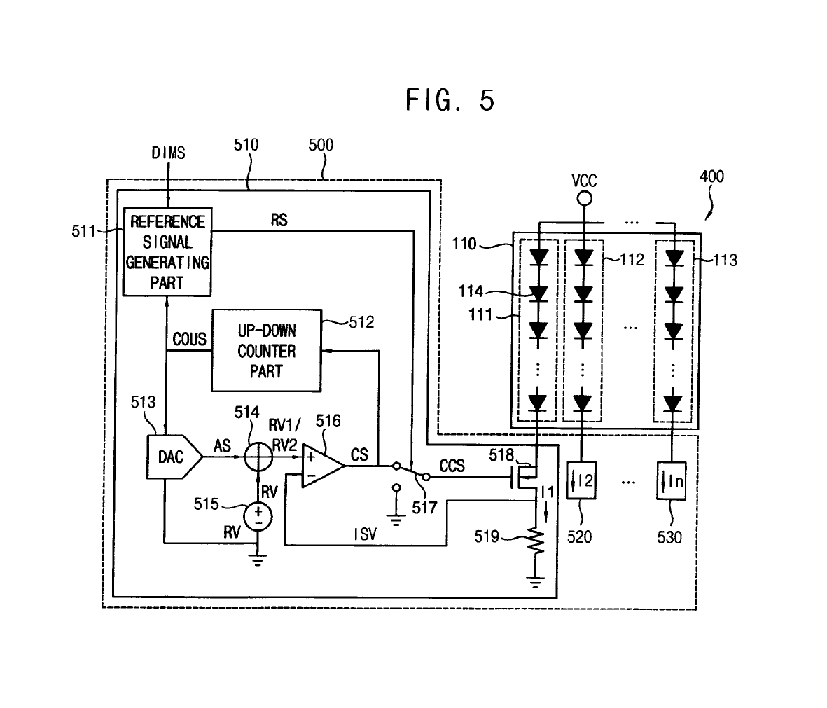

FIG. 5 is a block diagram illustrating an alternative exemplary embodiment of a light source apparatus according to the invention.

Referring to FIG. 5, an exemplary embodiment of the light source apparatus 400 includes a light source part 110 and a light source driving apparatus 500.

The light source part 110 generates light, and a luminance of the light source part 110 may be controlled by a pulse width of a dimming signal DIMS. The light source part 110 may include first to n-th light source strings, e.g., a first light source string 111, a second light source string 112 and an n-th light source string 113. The light source strings 111, 112 and 113 are connected to each other in parallel, and receive a power voltage VCC. In an exemplary embodiment, each of the light source strings 111, 112 and 113 may include a plurality of light sources 114. In one exemplary embodiment, for example, the light source 114 may be an LED.

A first current I1 flows in the first light source string 111 of the light source strings 111, 112 and 113. A second current I2 flows in the second light source string 112 of the light source strings 111, 112 and 113. An n-th current In flows in the n-th light source string 113 of the light source strings 111, 112 and 113.

The light source driving apparatus 500 includes first to n-th light source driving apparatuses 510, 520 and 530. The first to n-th light source driving apparatuses 510, 520 and 530 drive the first to n-th light source strings 111, 112 and 113, respectively.

The first light source driving apparatus 510 includes a reference signal generating part 511, an up-down counter part 512, a digital-analog converting part 513 (referred to as “DAC” in FIG. 5), an adding part 514, a reference voltage generating part 515, a comparing part 516, a switching part 517 and a current controlling part 518.

The reference signal generating part 511 outputs a reference signal RS synchronized with the dimming signal DIMS. The reference signal RS may include a frequency detection signal generated based on a frequency of the dimming signal DIMS, a duty ratio detection signal generated based on a duty ratio of the dimming signal DIMS, and an amplitude detection signal generated based on an amplitude of the dimming signal DIMS. In one exemplary embodiment, for example, the reference signal generating part 511 may include the frequency detecting part 211, the duty ratio detecting part 212, the synchronization signal generating part 213 and the multiplying part 214 of FIG. 1.

The comparing part 516 compares a current detection voltage ISV with a first reference voltage RV1 to output a comparison signal CS. The current detection voltage ISV is generated from the first current I1 flowing in the light source 114. The first reference voltage RV1 may be substantially the same as a reference voltage RV generated from the reference voltage generating part 515.

When a level of the current detection voltage ISV and a level of the first reference voltage RV1 are substantially the same as each other, the comparison signal CS in a low level may be outputted from the comparing part 516. When the level of the current detection voltage ISV is greater than the level of the first reference voltage RV1, the comparison signal CS in a high level may be outputted from the comparing part 516. In such an embodiment, the up-down counter part 512 is operated based on the comparison signal CS.

The up-down counter part 512 is operated based on the comparison signal CS outputted from the comparing part 516. In an exemplary embodiment, when the level of the current detection voltage ISV and the level of the first reference voltage RV1 are substantially the same as each other, the comparison signal CS is in the low level, and the up-down counter part 512 is thereby not operated. When the level of the current detection voltage ISV is greater than the level of the first reference voltage RV1, the comparison signal CS is in the high level, and the up-down counter part 512 is thereby operated. The up-down counter part 512 controls a step of an up-down counter therein based on the comparison signal CS having the high level to output an up-down counter signal COUS.

The reference signal generating part 511 decreases a duty ratio of the reference signal RS based on the up-down counter signal COUS.

The digital-analog converting part 513 increases a dimming step thereof based on the up-down counter signal COUS to output an analog signal AS. Thus, the digital-analog converting part 513 increases the analog signal AS based on the up-down counter signal COUS.

The adding part 514 performs an addition operation on the analog signal AS and the reference voltage RV to output a second reference voltage RV2. The second reference voltage RV2 is substantially the same as the current detection voltage ISV. In an exemplary embodiment, the comparison signal CS outputted from the comparing part 516 may be in the low level.

Each of the second light source driving apparatus 520 and the n-th light source driving apparatus 530 may be substantially the same as each other, and an average value of the first current I1 flowing in the first light source string 111, an average value of the second current I2 flowing in the second light source string 112 and an average value of the n-th current In flowing in the n-th light source string 113 may be substantially the same.

The switching part 517 electrically connects the comparing part 516 with the current controlling part 518 in response to the reference signal RS to output a current control signal CCS that controls the current flow in the light source 114. The current control signal CCS may have a frequency substantially the same as the frequency of the dimming signal DIMS.

The current controlling part 518 controls the current flow in the light source 114 based on the current control signal CCS. In an exemplary embodiment, the current controlling part 518 receives the current control signal CCS applied from the switching part 517, and controls the first current I1 flowing in the first light source string 111 based on the current control signal CCS. The current controlling part 518 may control a pulse width of the first current I1. The current controlling part 518 may include a switching element having a source terminal connected to the first light source string 111, a gate terminal receiving the current control signal CCS and a drain terminal in which the first current I1 flows. In one exemplary embodiment, for example, the switching element may be an FET.

The first light source driving apparatus 510 may further include a root mean square (“RMS”) value detecting part 519 connected between the current controlling part 518 and a ground terminal. The RMS value detecting part 519 detects an RMS value of the current flow in the light source 114. In an exemplary embodiment, the RMS value detecting part 519 detects an RMS value of the first current I1 flowing in the first light source string 111. The RMS value detecting part 519 may include a resistor having a first terminal connected to the current controlling part 518 and a second terminal connected to the ground terminal.

The second light source driving apparatus 520 is connected to the second light source string 112, and controls the second current I2 flowing in the second light source string 112. The second light source driving apparatus 520 is substantially the same as the first light source driving apparatus 510 except that the second light source driving apparatus 520 is connected to the second light source string 112 and controls flowing the second current I2.

The n-th light source driving apparatus 530 is connected to the n-th light source string 113, and controls the n-th current In flowing in the n-th light source string 113. The n-th light source driving apparatus 530 is substantially the same as the first light source driving apparatus 230 except that the n-th light source driving apparatus 520 is connected to the n-th light source string 113 and controls the n-th current In.

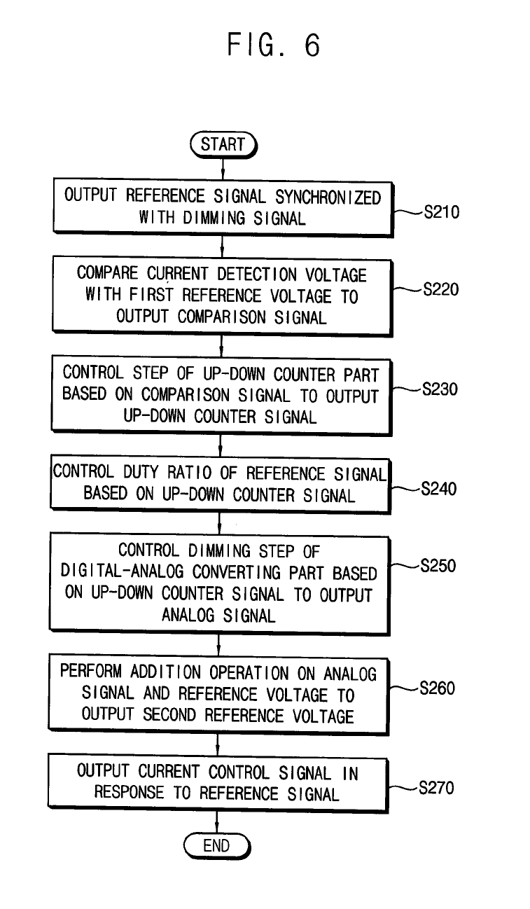

FIG. 6 is a flow chart illustrating an exemplary embodiment of a method of driving a light source performed by the light source driving apparatus of FIG. 5.

Referring to FIGS. 5 and 6, the reference signal RS synchronized with the dimming signal DIMS is outputted (S210). In an exemplary embodiment, the reference signal generating part 511 outputs the reference signal RS synchronized with the dimming signal DIMS. The reference signal RS may include the frequency detection signal detecting the frequency of the dimming signal DIMS, the duty ratio detection signal detecting the duty ratio of the dimming signal DIMS, and the amplitude detection signal detecting the amplitude of the dimming signal DIMS.

The current detection voltage ISV and the first reference voltage RV1 are compared with each other, and the comparison signal CS is thereby outputted (S220). In an exemplary embodiment, the comparing part 516 compares the current detection voltage ISV with the first reference voltage RV1 to output the comparison signal CS. The current detection voltage ISV is generated from the first current I1 flowing in the light source 114. The first reference voltage RV1 is substantially the same as the reference voltage RV generated from the reference voltage generating part 515.

When the level of the current detection voltage ISV and the level of the first reference voltage RV1 are substantially the same as each other, the comparison signal CS outputted from the comparing part 516 may be in the low level. When the level of the current detection voltage ISV is greater than the level of the first reference voltage RV1, the comparison signal CS outputted from the comparing part 516 may be in the high level. In an exemplary embodiment, the up-down counter part 512 is operated based on the comparison signal CS.

The step of the up-down counter part 512 is controlled by the comparison signal CS and the up-down counter signal COUS is outputted (S230). In an exemplary embodiment, the up-down counter part 512 is operated based on the comparison signal CS outputted from the comparing part 516. In such an embodiment, when the level of the current detection voltage ISV and the level of the first reference voltage RV1 are substantially the same as each other, the comparison signal CS is in the low level, and the up-down counter part 512 is thereby not operated. When the level of the current detection voltage ISV is greater than the level of the first reference voltage RV1, the comparison signal CS is in the high level, and the up-down counter part 512 is thereby operated. The up-down counter part 512 controls the step of up-down counter in the up-down counter part 512 based on the comparison signal CS having the high level to output the up-down counter signal COUS.

The duty ratio of the reference signal RS is controlled, e.g., decreased, based on the up-down counter signal COUS (S240).

The dimming step of the digital-analog converting part 513 is controlled by the up-down counter signal COUS, and the analog signal AS is thereby outputted (S250). In an exemplary embodiment, the digital-analog converting part 513 increases the dimming step thereof based on the up-down counter signal COUS to output the analog signal AS. Thus, the digital-analog converting part 513 increases the analog signal AS based on the up-down counter signal COUS.

The addition operation on the analog signal AS and the reference voltage RV is performed and the second reference voltage RV2 is outputted (S260). In an exemplary embodiment, the adding part 514 performs the addition operation on the analog signal AS and the reference voltage RV to output the second reference voltage RV2. The second reference voltage RV2 may be substantially the same as the current detection voltage ISV. In this case, the comparison signal CS outputted from the comparing part 516 may be in the low level. Thus, the average value of the first current I1 flowing in the first light source string 111, the average value of the second current I2 flowing in the second light source string 112 and the average value of the n-th current In flowing in the n-th light source string 113 may be substantially the same as each other.

The current control signal CCS is outputted in response to the reference signal RS (S270). In an exemplary embodiment, the switching part 517 electrically connects the comparing part 516 with the current controlling part 518 in response to the reference signal RS to output the current control signal CCS for controlling the current flow in the light source 114. The current control signal CCS may have the frequency substantially the same as the frequency of the dimming signal DIMS.

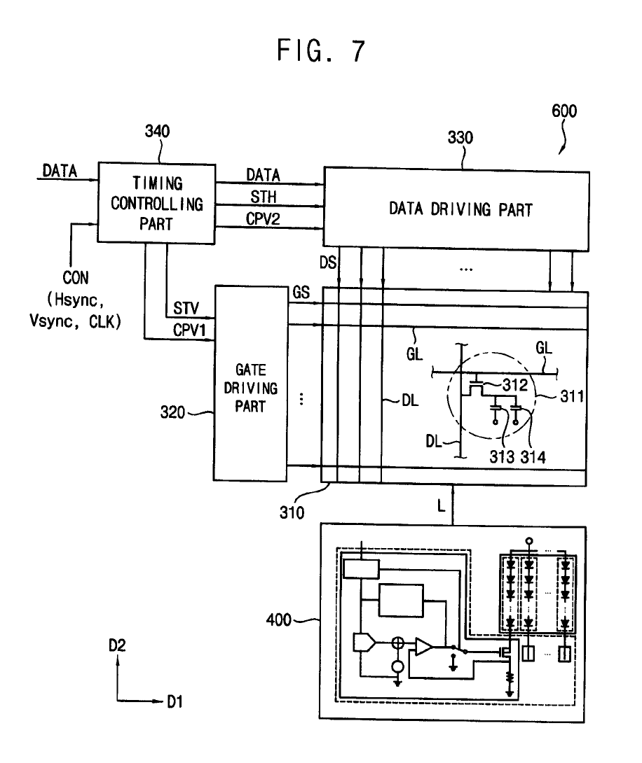

FIG. 7 is a block diagram illustrating an exemplary embodiment of a display apparatus including the light source apparatus 400 of FIG. 5.

Referring to FIGS. 5 and 7, an exemplary embodiment of the display apparatus 600 includes a display panel 310, a gate driving part 320, a data driving part 330, a timing controlling part 340 and the light source apparatus 400.

The display panel 310, the gate driving part 320, the data driving part 330 and the timing controlling part 340 shown in FIG. 7 is substantially the same as the display panel 310, the gate driving part 320, the data driving part 330 and the timing controlling part 340 of FIG. 4, and any repetitive detailed description thereof will be omitted.

The light source apparatus 400 provides light L to the display panel 310. The light source apparatus 400 includes the light source part 110 and the light source driving apparatus 500.

The light source part 110 generates the light L, and the light source driving apparatus 500 drives the light source part 110.

The light source apparatus 400 of FIG. 7 is substantially the same as the light source apparatus 400 of FIG. 5, and any repetitive detailed description thereof will be omitted.

According to exemplary embodiments set forth herein, the frequency of the current control signal CCS for controlling the current flow in the light source 114 is substantially the same as the frequency of the dimming signal DIMS, such that a number of turning on and off of the switching element that receives the current control signal CCS is substantially reduced, and thus heating of the switching element and switching loss of the switching element may be decreased.

According to exemplary embodiments of the method of driving a light source, the light source driving apparatus and the display apparatus having the light source driving apparatus, a frequency of a current control signal for controlling a current flow in the light source is substantially the same as a frequency of a dimming signal, such that a number of turning on and off of a switching element that receives the current control signal may be decreased, and thus heating of the switching element and switching loss of the switching element may be decreased.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of driving a light source, the method comprising:
detecting a frequency of a dimming signal, which controls a luminance of the light source, to output a frequency detection signal; and
outputting a current control signal, which controls a current flow in the light source, based on the frequency detection signal,
wherein the current control signal has a frequency substantially the same as the frequency of the dimming signal.

2. The method of claim 1, further comprising:
detecting a duty ratio of the dimming signal to output a duty ratio detection signal.

3. The method of claim 2, further comprising:
outputting a synchronization signal, which is synchronized with the dimming signal, based on the frequency detection signal.

4. The method of claim 3, wherein the synchronization signal has a triangular waveform.

5. The method of claim 3, further comprising:
multiplying the synchronization signal by the duty ratio detection signal to output a reference signal.

6. The method of claim 5, wherein the reference signal has a triangular waveform.

7. The method of claim 5, further comprising:
detecting the current flow in the light source to output a current detection signal.

8. The method of claim 7, wherein the outputting the current control signal comprises comparing the reference signal with the current detection signal.

9. The method of claim 1, further comprising:
comparing a current detection signal with a first reference voltage to output a comparison signal, wherein the current detection signal is generated based on the current flow in the light source, and the first reference voltage is substantially same as a reference voltage;
controlling a step of an up-down counter based on the comparison signal to output an up-down counter signal;
controlling a duty ratio of a reference signal based on the up-down counter signal, wherein the reference signal is synchronized with the dimming signal;
controlling a dimming step of a digital-analog converting part based on the up-down counter signal to output an analog signal; and
adding the reference voltage to the analog signal to output a second reference voltage.

10. A light source driving apparatus comprising:
a frequency detecting part configured to detect a frequency of a dimming signal, which controls a luminance of a light source, to output a frequency detection signal; and
a current control signal outputting part configured to output a current control signal, which controls a current flow in the light source, based on the frequency detection signal,
wherein the current control signal has a frequency substantially the same as the frequency of the dimming signal.

11. The light source driving apparatus of claim 10, further comprising:
a duty ratio detecting part configured to detect a duty ratio of the dimming signal to output a duty ratio detection signal.

12. The light source driving apparatus of claim 11, further comprising:
a synchronization signal generating part configured to receive the frequency detection signal to output a synchronization signal, which is synchronized with the dimming signal, based on the frequency detection signal.

13. The light source driving apparatus of claim 12, further comprising:
a multiplying part configured to multiply the synchronization signal by the duty ratio detection signal to output a reference signal.

14. The light source driving apparatus of claim 10, further comprising:
a current detecting part configured to detect the current flow in the light source to output a current detection signal.

15. The light source driving apparatus of claim 10, further comprising:
a comparing part configured to compare a current detection signal with a first reference voltage to output a comparison signal, wherein the current detection signal is generated based on the current flow in the light source, and the first reference voltage is substantially same as a reference voltage;
an up-down counter part configured to control a step of an up-down counter therein based on the comparison signal to output an up-down counter signal;
a reference signal generating part configured to control a duty ratio of a reference signal based on the up-down counter signal, and configured to output the reference signal synchronized with the dimming signal;
a digital-analog converting part configured to control a dimming step of the digital-analog converting part based on the up-down counter signal to output an analog signal; and
an adding part configured to add the reference voltage to the analog signal to output a second reference voltage.

16. A display apparatus comprising:
a display panel configured to display an image;
a light source part configured to provide light to the display panel; and
a light source driving apparatus comprising:
a frequency detecting part configured to detect a frequency of a dimming signal, which controls a luminance of a light source in the light source part, to output a frequency detection signal; and
a current control signal outputting part configured to output a current control signal, which controls a current flow in the light source, based on the frequency detection signal,
wherein the current control signal has a frequency substantially same as the frequency of the dimming signal.

17. The display apparatus of claim 16, wherein the light source part comprises a plurality of light source strings connected to each other in parallel.

18. The display apparatus of claim 17, wherein each of the light source strings comprises a plurality of light sources.

19. The display apparatus of claim 17, wherein the current flows in the light source strings have a frequency substantially the same as the frequency of the dimming signal.

20. The display apparatus of claim 17, wherein the current flows in the light source strings have pulse widths different from each other.
